(19) United States
(12) Patent Application Publication
(10) Pub. No.: US 2004/0141507 A1
(43) Pub. Date: Jul. 22, 2004

(54) Method and device for controlling paths for ip connection in a user-specific communication network

(76) Inventor: Uwe Michel, Bad Honnef (DE)

Correspondence Address: THE MAXHAM FIRM, 750 "B" STREET, SUITE 3100, SAN DIEGO, CA, 92101, US

(21) Appl. No.: 10/473,914

(22) PCT Filed: Mar. 26, 2002
(86) PCT No.: PCT/DE02/01105

(30) Foreign Application Priority Data
Apr. 5, 2001 (DE) 101 17 133.1

(51) Int. Cl. H04L 12/28

(52) U.S. Cl. 370/395.52

(57) ABSTRACT

The invention pertains to a process to control the path of IP connections in a subscriber-based communication network, in particular in a digital mobile communication network, through which the IP connections are routed depending on the subscriber data. The device to perform the process includes a database in which a relation between an IP address assigned to a subscriber, a subscriber identity and a subscriber profile is stored, a RADIUS proxy server that creates the relation between the IP address and the subscriber identity when the IP address is assigned and that writes this to the database, and a router that performs a query of the database for each IP data packet of the IP connection and performs the routing to the destination system depending on the subscriber data.

This invention pertains to a process and a device to control the path of (route) IP connections in a subscriber-based communication network according to the preamble of the independent patent claims.

The following systems are currently part of the prior art, said systems selecting and routing IP traffic based on different criteria, with IP traffic being understood to mean data connections that use Internet Protocol (IP):

Classic router

A normal router steers traffic based only on the destination IP address

Firewall

A firewall filters out certain types of traffic based on the IP addresses contained in the traffic stream and based on the protocol layers used. To this end, however, it only considers those data that are directly contained in the IP traffic stream and that are depicted in rules stored in the firewall.

Load distributor

A load distributor distributes traffic between multiple destination systems based on load or statistics. None of the known systems uses subscriber-based criteria or profiles filed for the subscriber as a basis for the routing process.

GPRS

The packet-oriented GPRS network is a combination of HLR and SGSN and contains similar functions. However, this system was not designed for circuit-switched data IP traffic.

The objective of this invention is to propose a process and a device to control the path of IP connections in a subscriber-based communication network in which individual subscriber criteria are used to control the routing.

This objective is met by the features of the independent patent claims.

The system according to the invention allows the routing of IP traffic in a mobile network to be done depending on the subscriber data.

A significant advantage of the invention is that the system can be implemented independent of the access network.

A possible application of a system of this type, for example in a digital mobile phone communications network, is to deliberately allow or deny certain mobile phone subscribers access to specific destination networks (or to network elements within a network). Thus, a certain group of mobile phone subscribers (a corporate customer) can be granted access to Intranets, while at the same time incorporating the desire to exclude access to the public Internet. Another application is the distribution of WAP traffic (WAP: wireless application protocol) onto different WAP proxies in order to deliberately direct special mobile phone services that require the use of a special WAP proxy to the correct WAP proxy for the respective subscriber.

Advantageous embodiments and developments of the invention are contained in the dependent patent claims.

It is preferred that the subscriber data of subscribers in the communication network be stored in a special database under an associated subscriber identity and that they be queried there.

A subscriber identity is first transmitted to a RADIUS server in a known fashion over the communication network as a connection is set up. The RADIUS server assigns an IP address for the subscriber dynamically and transmits this to the communication network. This connection between the communication network and the RADIUS server is overseen by a RADIUS proxy server that records the IP address assigned to the subscriber and the associated subscriber identity and relates this information to the subscriber data stored in the database, and then stores this relation there. If more than one RADIUS server is used, the RADIUS proxy server oversees the connections to all of these various RADIUS servers.

During the connection, any IP traffic is now sent from the communication network to a special router, wherein each individual incoming IP data packet initiates a query of the database, and the routing to the destination system depends on the subscriber identity and the associated subscriber profile detected.

In the process, it does not matter whether the destination system is a destination communication network (APN) or only a specific network element.

Depending on the subscriber data stored in the database, certain destination addresses can now be blocked for the corresponding subscriber and/or the destination IP addresses present in the traffic stream can be manipulated.

A device to carry out the process involves essentially a database that stores a relation between an IP address assigned to a subscriber, a subscriber identity and a subscriber profile, a RADIUS proxy server that creates the relation between the IP address and the subscriber identity when the IP address is assigned and that writes this information into the database, and a router that executes a query of the database for each IP data packet in the IP connection and that performs the routing to the destination system depending on the subscriber data.

In the following, the invention is explained in more detail by means of an exemplary embodiment that refers to the drawings. Further features, advantages and applications of the invention can be found in the drawings and in their description.

Shown are:

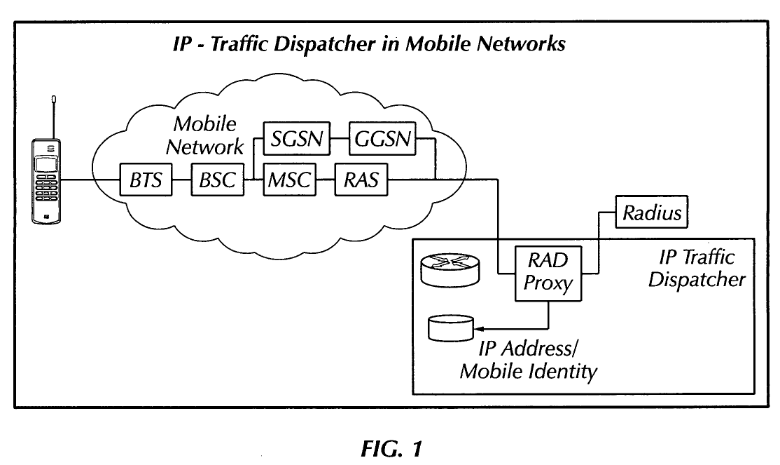

FIG. 1: the setup of an IP connection with IP address assignment;

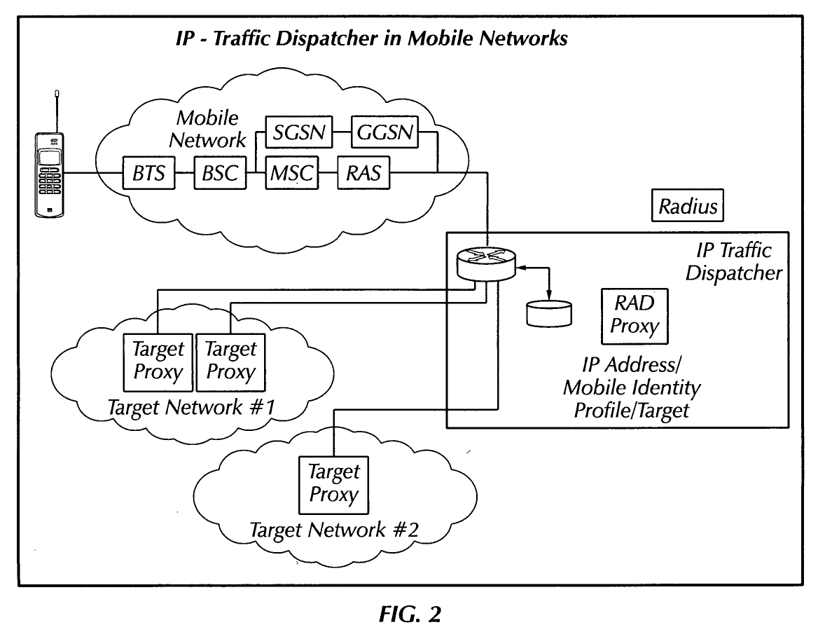

FIG. 2: the routing process after a successful IP address assignment.

The way the system works is illustrated through the two drawings.

FIG. 1 illustrates the setup of an IP connection (typically a point-to-point connection) between a mobile communication end device 1 of a subscriber of the mobile communication network 2 and a destination system that can be another destination communication network 13, 15 or even just a specific network element 14, 16 in a destination communication network.

The mobile communication network 2 includes the known network elements that are necessary to set up a connection, such as base station 3, base station controls 4 and mobile switching center 5. Furthermore, GPRS network elements, such as GPRS service nodes 7 and GPRS gateway 8 (transfer switching) can be present, which, however, are not important aspects of the invention.

To set up an IP connection, a remote access server 6 (RAS) is used, which provides the dial-up service to the Internet, for example. For each Internet connection, it is necessary to assign a temporary IP address that is valid only for the respective connection. The data is then routed using this IP address.

To assign an IP address, the RADIUS protocol is used in this example (or a similar protocol), which is prepared by a RADIUS server 17. The mobile communication network 2 transmits the subscriber identity of the subscriber, which is stored in a subscriber identity module (SIM) in the mobile communications end device 1, to the RADIUS server 17. The server in turn dynamically assigns an IP address to the mobile phone subscriber and transmits it back to the mobile communications network 2.

According to the invention, a special routing system 9 is installed between the mobile phone network 2 and RAS 6 that oversees the assignment of the IP addresses. The routing system 9 includes a RADIUS proxy server 10. In general, a proxy server is understood as a device that receives requirements from a client and forwards them, if necessary modified, to a destination.

As the IP address is assigned, the RADIUS proxy server 10 detects the IP address and the associated subscriber identity (IMSI or MSISDN) of the subscriber, links them together and writes them to an internal system database 11.

If more than one different RADIUS servers 17 are used in connection with a mobile communications network 2 (e.g. since connected Internet Service Providers assign the IP addresses), all RADIUS connections are overseen by the RADIUS proxy server 10. The relation between the subscriber identity and the IP address is directly written by the RADIUS proxy server 10 to the internal database 11 of the routing system 9.

Prior to this, an administrative process was performed, by means of external systems if necessary, which stored the corresponding subscriber data of the subscribers to the mobile communication network 2 under the respective individual subscriber identities. This process is used to store the subscriber data of all subscribers or selected groups. The IP address detected by the proxy server 10 is used to link the IP address assigned to a subscriber to the subscriber identity and the subscriber data (subscriber profile) in the database 11.

In this way, the routing system 9 can now depict the subscriber profile onto IP addresses.

FIG. 2 illustrates the actual routing process after a successful IP address assignment. The mobile communication network 2 sends all IP traffic of the respective IP connection to a router 12 of the routing system 9 according to the invention. The router 12 carries out a query of the corresponding subscriber data in the database 11 for each individual IP data packet that it receives in connection with the associated IP address. Depending on the subscriber identity detected and on the corresponding subscriber profile, the routing to a destination system then takes place. The destination system can in the process be an entire destination communication network 13, 15 or can also be merely a certain network element, such as a destination proxy server 14, 16.

The routing system 9 according to the invention thus activates certain output ports depending on the subscriber data; in other words it blocks certain destination addresses and/or manipulates the IP addresses present in the traffic stream as necessary.

### Drawing Legend

1 Mobile Communication End Device

2 Mobile Communication Network

3 Base Station

4 Base Station Controls

5 Mobile Switching Station

6 Remote Access Server

7 GPRS Service Node

8 GPRS Gateway

9 Routing System

10 RADIUS Proxy Server

11 Database

12 Router

13 Destination Communication Network

14 Destination Proxy Server

15 Destination Communication Network

16 Destination Proxy Server

17 RADIUS Server

1. A process to control the path of IP connections in a subscriber-based communication network, in particular in a digital mobile communications network, characterized in that
the IP connections are routed depending on the subscriber data.

2. A process according to claim 1, characterized in that the subscriber data about subscribers of the communication network (2) are stored in a database (11) under the respective subscriber identity, and can be queried there.

3. A process according to one of the previous claims, characterized in that as the connection is set up, a subscriber identity is transmitted over the communications network (2) to a RADIUS server (17), wherein the RADIUS server (17) dynamically assigns an IP address for the subscriber and transmits it to the communications network (2).

4. A process according to one of the previous claims, characterized in that the connection between the communications network (2) and the RADIUS server (17) is overseen by a RADIUS proxy server (10) that detects die IP address assigned to the subscriber and the associated subscriber identity and creates and stores a relation to the subscriber data stored in the database (11).

5. A process according to one of the previous claims, characterized in that the connections to more than one different RADIUS servers (17) are overseen by the RADIUS proxy server (10).

6. A process according to one of the previous claims characterized in that during the connection, any IP traffic is sent from the communication network (2) to a router (12), wherein each individual incoming IP data packet initiates a query of the database (11) and that the routing to the destination system (13, 16) occurs depending on the detected subscriber identity and the associated subscriber profile.

7. A process according to one of the previous claims, characterized in that the destination system is a destination network (13, 15) or a specific network element (14, 16).

8. A process according to one of the previous claims, characterized in that certain destination addresses are blocked and/or the destination IP addresses present in the traffic stream are manipulated depending on the subscriber data stored in the database (11).

9. A device to control the path of IP connections in a subscriber-based communication network, in particular in a digital mobile communication network, characterized by:
a database (11) in which a relation between an IP address assigned to a subscriber, a subscriber identity and a subscriber profile is stored;
a RADIUS proxy server (10) that creates the relation between the IP address and the subscriber identity when the IP address is assigned, and that writes it to the database (11); and
a router (12) that performs a query of the database (11) for each IP data packet in the IP connection and performs the routing to the destination system (13-16) depending on the subscriber data.
